(19) United States
(12) Patent Application Publication
(10) Pub. No.: US 2018/0350551 A1
(43) Pub. Date: Dec. 6, 2018

(54) X-RAY ASSEMBLY

(71) Applicant: VAREX IMAGING CORPORATION, Salt Lake City, UT (US)

(72) Inventors: Kasey Otho GREENLAND, Salt Lake City, UT (US); Robert S. MILLER, Salt Lake City, UT (US); Michael STAMM, Salt Lake City, UT (US)

(73) Assignee: VAREX IMAGING CORPORATION, Salt Lake City, UT (US)

(21) Appl. No.: 15/781,083

(22) PCT Filed: Dec. 3, 2015
(86) PCT No.: PCT/US2015/063771

§ 371 Date: Jun. 1, 2018

(51) Int. Cl. H01J 35/10; H01J 35/16; H01J 35/14

(52) U.S. Cl. CPC H01J 35/101; H01J 35/105; H01J 2235/168; H01J 35/14; H01J 2235/1086; H01J 35/16

(57) ABSTRACT

An X-ray assembly may include a vacuum wall, an anode, and a cathode. The vacuum wall may define a vacuum enclosure and may include an X-ray window. The anode may be located within the vacuum enclosure. The anode may include a target area. The cathode may be located within the vacuum enclosure. The cathode may generate an electron stream to travel to a focus area located at the target area of the anode. The cathode may be positioned such that the electron stream travels along an oblique path relative a virtual line positioned so as to intersect a center of the focus area and a center of the X-ray window.

### BACKGROUND

### Field

The embodiments discussed herein are related to X-ray assemblies.

### Relevant Technology

X-ray assemblies may be used to produce X-rays for use in material analysis, imaging, radiation treatment, and the like. The subject matter claimed herein is not limited to embodiments that operate only in environments such as those described above. Rather, this background is only provided to illustrate one example technology area where some embodiments described herein may be practiced.

### SUMMARY

Embodiments may relate to X-ray assemblies.

This Summary introduces a selection of concepts in a simplified form that are further described below in the Detailed Description. This Summary is not intended to identify key features or essential characteristics of the claimed subject matter, nor is it intended to be used as an aid in determining the scope of the claimed subject matter.

In an embodiment, an X-ray assembly may include a vacuum wall, an anode, and a cathode. The vacuum wall may define a vacuum enclosure and may include an X-ray window. The anode may be located within the vacuum enclosure. The anode may include a target area. The cathode may be located within the vacuum enclosure. The cathode may generate an electron stream to travel to a focus area located at the target area of the anode. The cathode may be positioned such that the electron stream travels along an oblique path relative a virtual line positioned so as to intersect a center of the focus area and a center of the X-ray window

In another embodiment, an X-ray assembly may include a vacuum wall, an anode, a cathode, and an aperture structure. The vacuum wall may define a vacuum enclosure and may include an X-ray window. The anode may be located within the vacuum enclosure. The anode may be rotatably positioned about an axis relative to the vacuum wall via a bearing structure including a liquid metal bearing. The anode may include a target area. The cathode may be located within the vacuum enclosure. The cathode may generate an electron stream to travel to a focus area located at the target area of the anode adjacent the X-ray window of the vacuum wall. The cathode may be offset from the focus area in a direction parallel to the axis of the anode and in a direction perpendicular to the axis of the anode. The aperture structure may define an aperture located between the cathode and the focus area.

Additional features and advantages will be set forth in the description which follows, and in part will be obvious from the description, or may be learned by the practice of the embodiments. The features and advantages of the embodiments will be realized and obtained by means of the instruments and combinations particularly pointed out in the claims. These and other features will become more fully apparent from the following description and claims, or may be learned by the practice of the embodiments as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a cross-section of an example X-ray assembly;

FIG. 2 illustrates a cross-section of another example X-ray assembly;

FIG. 3 illustrates a cross-section of another example X-ray assembly;

FIG. 4 illustrates a cross-section of another example X-ray assembly;

FIG. 5 illustrates a cross-section of another example X-ray assembly;

FIG. 6 illustrates a cross-section of another example X-ray assembly; and

FIG. 7 illustrates a cross-section of another example X-ray assembly.

### DESCRIPTION OF EMBODIMENTS

Employing relatively higher voltages, such as voltages above 150 kilovolts, in X-ray assemblies may result in high voltage conductors of the X-ray assemblies producing relatively stronger electric fields. Some X-ray assembly configurations may not be capable of stable operation at the relatively high voltage as a result of the effects of the relatively stronger electric fields. Increasing the distances between a high voltage conductor, grounded surfaces, and/or an opposing high voltage conductor may accommodate relatively stronger electric fields to further accommodate X-ray assemblies capable of stable operation at the relatively high voltage. For example, conventional X-ray assemblies may be made relatively larger to accommodate relatively larger voltages. These conventional X-ray assemblies may exhibit a relative decrease in X-ray intensity, resolution capacity, and/or efficiency. In some instances, the conventional X-ray assembly may include a relatively increased distance between the source of the X-rays and the area from which the X-rays exit the X-ray assembly and/or reach an area clear of the X-ray assembly.

In some embodiments, an X-ray assembly may be configured such that distances between high voltage conductors and/or grounded surfaces are relatively increased while reducing or eliminating a corresponding relative increase in the overall size of the X-ray assembly. For example, an X-ray assembly may include a cathode offset relative to a focus area of an anode such that an electron beam traveling from the cathode to the focus area travels at an angle relative to an axis of the anode. The offset position of the cathode may accommodate a relative increase in distance between the cathode and a vacuum wall of the X-ray assembly without a corresponding relative increase in the size of the X-ray assembly. In some embodiments, the X-ray assembly may include an aperture structure defining an aperture located between the cathode and the focus area. In some embodiments, an X-ray assembly may position a focus area of an anode relatively near an X-ray window of the X-ray assembly. Alternately or additionally, the focus area of the anode may be positioned relatively near an outer surface of a vacuum wall of the X-ray assembly. For example, a distance traveled by X-rays from the X-ray source to an area clear of the vacuum wall may be shortened relative to conventional X-ray assemblies. Thus, for example, an object to be exposed to X-rays may be positioned relatively closer to the X-ray source. In some embodiments, the X-ray assembly may exhibit an increase in X-ray intensity, resolution capacity, and/or efficiency relative to conventional X-ray assemblies.

Reference will now be made to the figures wherein like structures will be provided with like reference designations. The drawings are diagrammatic and schematic representations of exemplary embodiments and, accordingly, are not limiting of the scope of the claimed subject matter, nor are the drawings necessarily drawn to scale.

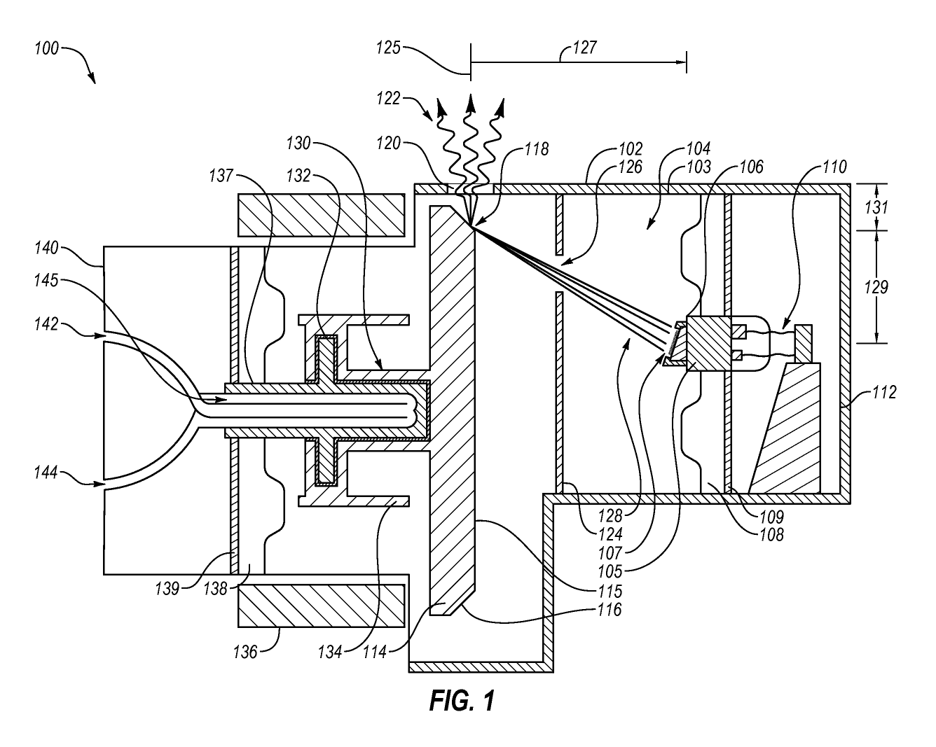

FIG. 1 illustrates a cross-section of an example X-ray assembly 100. In some embodiments, the X-ray assembly 100 may include an industrial X-ray assembly, which may operate at a relatively higher voltage than other X-ray assemblies, such as, for example, medical X-ray assemblies. The X-ray assembly includes a housing 102 and a vacuum wall 103 defining a vacuum enclosure 104. Thus, for example, the X-ray assembly 100 may be a sealed X-ray tube. The sealed housing 102 may require less maintenance relative to a demountable tube. The housing 102 may include metal, glass, and/or other suitable materials. In some embodiments, the volume between the housing 102 and the vacuum wall 103 may be oil filled.

The X-ray assembly 100 includes a cathode 106 and an anode 114 located within the vacuum enclosure 104. The X-ray assembly 100 may include an insulator 108 located adjacent to the cathode 106. Alternately or additionally, the example X-ray assembly 100 may include an insulator positioned on a stem 105 of the cathode 106. In some embodiments, the X-ray assembly 100 may include a gasket 109 positioned between the insulator 108 and a receptacle 112. In some embodiments, the receptacle 112 may include conductive connectors 110 connected to the cathode 106 and facilitating control of the cathode 106. Alternately or additionally, the receptacle 112 may include a cable connection.

In some embodiments, a face 131 of the cathode 106 may be angled relative to the stem 105 of the cathode 106. Alternately or additionally, the stem 105 of the cathode may include a bend. Alternately or additionally, the stem 105 may be positioned at an angle relative to the receptacle 112 and the insulator 108 may include an angled opening to accommodate the stem 105. The cathode 106 may include a high voltage shield 111. In some embodiments, an opening in the high voltage shield 111 may be oriented with the face 107 of the cathode 106. Alternately, the opening in the high voltage shield 111 may be oriented at an angle relative to the face 107 of the cathode 106.

The anode 114 may selectively rotate about an axis 117. The anode 114 includes a target area 116, which may also be described as a focal track. The anode 114 may be at a relatively high, positive voltage relative to the cathode 106. The cathode 106 may produce an electron stream 128, having a negative charge, may be attracted to the positively charged anode 114. Thus for example, the electron stream 128 may travel to the anode 114 and impact the target area 116 at a focus area 118. The focus area 118 may be adjacent to an X-ray window 120 in the housing 102 and the vacuum wall 103, such that an X-ray beam 122 produced by the impact of the electron stream 128 with the target area 116 may exit the housing 102.

In some embodiments, the anode 114 and the cathode 106 may have a voltage difference of greater than 150 kilovolts (kV). In some embodiments, the anode 114 and the cathode 106 may have a voltage difference of greater than 225 kV. In some embodiments, the anode 114 may have a ground voltage relative to the cathode 106. Alternately, the cathode 106 may have a ground voltage relative to the anode 114. Alternately, the cathode 106 may have a negative voltage and the anode 114 may have a positive voltage such that the cathode 106 and the anode 114 exhibit the desired voltage difference.

The anode 114 may be made to rotate about the axis 117 such that the focus area 118 does not remain at the same area of the target area 116 for long. A significant amount of heat may be generated at the focus area 118 and rotating the anode 114 may allow the X-ray beam 122 to be generated for a relatively significant period of time without destroying the anode 114. The anode 114 may accommodate a relatively smaller focus area 118 for a given power input compared to a fixed anode. Thus, for example, resolution may be improved for a given power input relative to a fixed anode. Furthermore, a higher power input may be accommodated for a given focus area size, which may encourage a higher X-ray beam 122 flux and thus, for example, shorter inspection times relative to a fixed anode. Additionally, a greater continuous power density may be directed to the target area 116 of the anode 114, resulting in a higher brilliance relative to a fixed anode.

The anode 114 may be rotatably positioned relative to the housing 102 via a bearing structure 130. The bearing structure 130 may include a liquid metal bearing 132. The liquid metal bearing 132 is a form of hydrodynamic bearing. The bearing structure 130 may include one or more spiral grooves facing the liquid metal bearing 132. The anode 114 may be attached to a rotor 134. The rotor 134, and thus the anode 114, may be encouraged to rotate by a stator 136. The rotor 134 may be located within the vacuum enclosure 104 and the stator 136 may be located outside of the vacuum enclosure 104. The liquid metal bearing 132 may exhibit an improved lifespan relative to a ball bearing structure.

In some embodiments, the bearing structure 130 may act as an interface between the anode 114 and a supporting shaft 137 positioned relative to the housing 102. The X-ray assembly 100 may include an insulator 138 located adjacent to the supporting shaft 137. In some embodiments, the insulator 138 may include a ceramic having a substantially larger diameter than thickness.

In some embodiments, the X-ray assembly 100 may include a gasket 139 located between the insulator 138 and a receptacle 140. In some embodiments, the receptacle 140 may include a cooling fluid input 142 and/or a cooling fluid output 144 for circulating coolant through coolant pathways 145 of the supporting shaft 137. In some embodiments, the receptacle 140 may include a cable having the cooling fluid input 142 and/or cooling fluid output 144 integrated with the cable.

Circulating coolant through the coolant pathways 145 may remove heat from the supporting shaft 137, the liquid metal bearing 132, and the anode 114. Thus, for example, heat generated in the production of the X-ray beam 122, and/or heat produced via friction experiences in the bearing structure 130 may be removed from the X-ray assembly 100 via coolant, circulating through the coolant pathways 145, which may enter via the cooling fluid input 142 and may exit via the cooling fluid output 144.

The cathode 106 may be offset 127 from the focus area 118 in a direction parallel to the axis 117. Furthermore, the cathode 106 may be offset 129 from the focus area 118 in a direction perpendicular to the axis 117. The offset 129 may discourage arcing between the cathode 106 and the housing 102, which may have a voltage different from the cathode 106. For example, the cathode 106 may have a relatively large negative voltage and the housing 102 may have a voltage relatively close to electrical ground. Thus, for example, the offset 129 may facilitate shaping the housing 102 in a relatively compact shape and/or size.

Alternately or additionally, the cathode 106 may be positioned such that the electron stream 124 travels to the focus area 118 along a path obliquely oriented relative to a virtual line 125 positioned to intersect a center of the focus area 118 and a center of the X-ray window 120. Put another way, the electron stream 124 may travel to the focus area 118 along a path having an oblique orientation relative to a center ray of the X-ray beam 122 and/or the axis 117.

The X-ray assembly 100 may include an aperture structure 124. In some embodiments, the aperture structure 124 may encourage the electron stream 128 to travel to the focus area 118 and not to the relatively closer portions of the anode 114. In some embodiments, the aperture structure 124 may be formed from copper.

The aperture structure 124 defines an aperture 126 located between the cathode 106 and the focus area 118. In some embodiments, the aperture structure 124 may include an insulator to discourage arcing between the cathode 106 and the aperture structure 124 and/or to discourage the aperture structure 124 from influencing the path of the electron stream 128. The aperture structure 124 may define the aperture 126 such that the aperture 126 creates a high voltage field that tends to flow the electron stream 128 from the cathode 106 at an oblique path relative to the axis 117 of the anode 114.

In some embodiments, the aperture structure 124 may include a wall substantially perpendicular to the axis 117 of the anode 114. Alternately, the aperture structure 124 may include a wall positioned at an angle relative to the axis 117 of the anode 114. In some embodiments, the aperture structure 124 may define a relatively flat aperture 126.

The aperture structure 124 may collect electrons back-scattered from the anode 114. In some embodiments, the aperture structure 124 may be configured to dissipate heat. For example, cooling channels may be formed in the aperture structure 124 and, in some embodiments, coolant may be circulated through the cooling channels. The aperture structure 124 may promote a relatively uniform high voltage field around the cathode 106.

In some embodiments, the X-ray assembly 100 may include a relatively short distance 131 between the focus area 118 and the housing 102. Thus, for example, the X-ray beam 122 may reach an area clear of the housing 102 in the relatively short distance 131. The relatively short distance 131 may accommodate an object to be placed relatively close to the source of the X-ray beam 122 (e.g., the focus area 118). By way of example, the X-ray assembly 100 may exhibit an increase in X-ray intensity, resolution capacity, and/or efficiency relative to conventional X-ray assemblies.

In some embodiments, the target area 116 may have a relatively larger angle relative to a face 115 of the anode 114. In some embodiments, the size of the X-ray window 120 may be related to the angle of the target area 116 relative to the face 115 of the anode 114. The relatively larger angle of the target area 116 may encourage relatively less X-ray attenuation at the anode 114. In some embodiments, the target area 116 may have an angle of 20 degrees or more relative to the face 115 of the anode 114.

A relatively larger angle of the target area 116 relative to the face 115 of the anode 114 may encourage a relatively smaller focus area 118 and a relatively higher temperature produced at the focus area 118. Thus, for example, temperatures generated at the focus area 118 may encourage a relatively lower power limit relative to a target area 116 having a relatively smaller angle. Furthermore, the projected focus area size may be relatively uniform for relatively uniform resolution across the area illuminated by the X-ray beam 122.

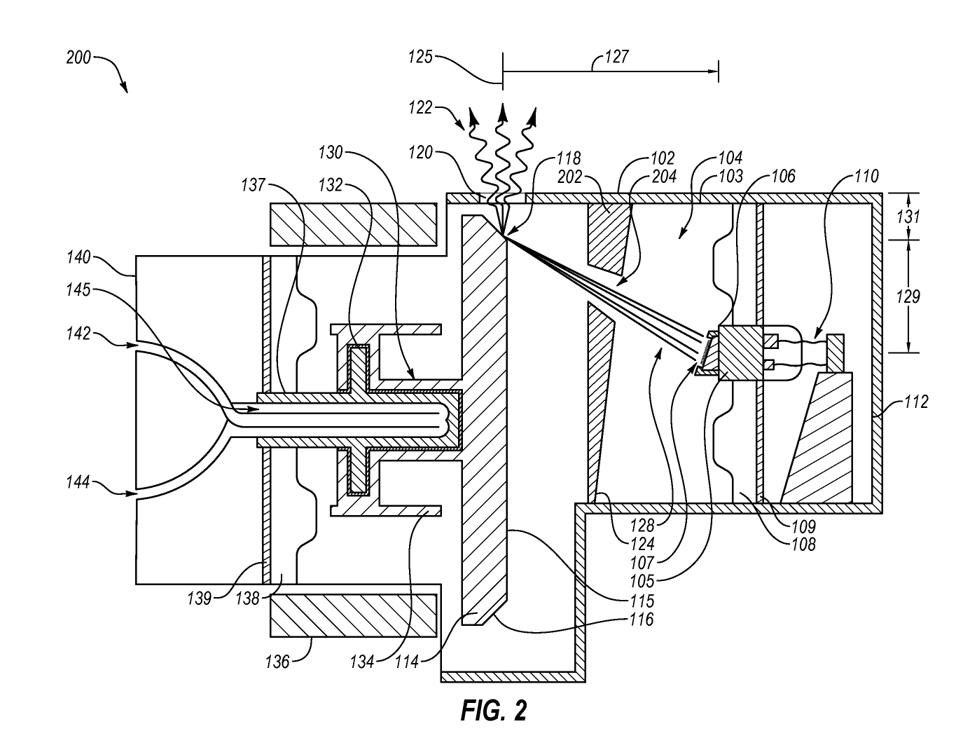

FIG. 2 illustrates a cross-section of an example X-ray assembly 200. The X-ray assembly 200 may correspond generally to the example X-ray assembly 100 of FIG. 1, but may include an alternate aperture structure 202 defining an aperture 204. The aperture structure 202 may encourage the electron stream 128 to the focus area 118 and not to the relatively closer portions of the anode 114. The shape of the aperture structure 202 may further discourage arcing between the cathode 106 and the housing 102. The aperture structure 202 may include a wedge-shaped cross-section. Alternately, the aperture structure 202 may include other shapes, including a substantially constant-thickness cross-section, a convex-shaped cross-section, a concave-shaped cross-section, or the like. For example, the aperture structure 202 may include a concave-shaped cross-section oriented such that the concave shape of the aperture structure 202 faces the cathode 106.

In some embodiments, the aperture structure 202 may define a relatively circular aperture 204. A centerline of the relatively circular aperture 204 may run non-parallel to the axis 117 of the anode 114. For example, a centerline of the aperture 204 shown in FIG. 2 may run approximately parallel to the general orientation of the electron stream 128. Alternately, the aperture structure 202 may define a non-circular aperture. A longitudinal line of the aperture 204 may run non-parallel to the axis 117 of the anode 114.

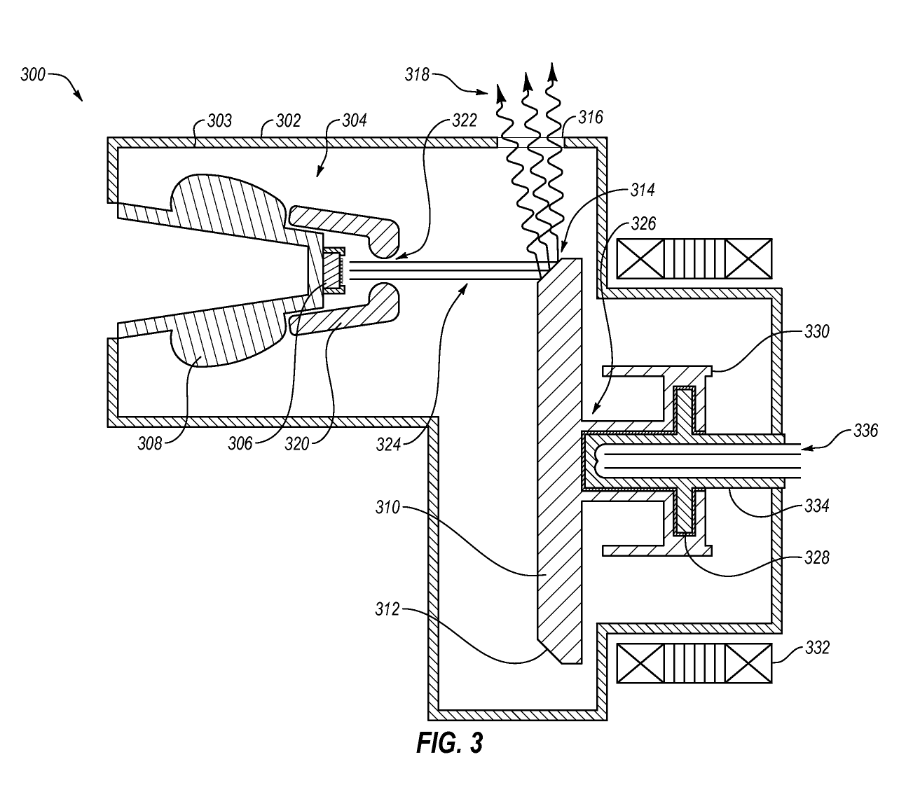

FIG. 3 illustrates a cross-section of an example X-ray assembly 300. The X-ray assembly 300 may include a housing 302, a vacuum wall 303, a vacuum enclosure 304, a cathode 306, an insulator 308, an anode 310, a target area 312, a focus area 314, an X-ray beam 318, an electron stream 324, a bearing structure 326, a liquid metal bearing 328, a rotor 330, a stator 332, a supporting shaft 334, and/or coolant pathways 336 generally corresponding, respectively, to the housing 102, the vacuum wall 103, the vacuum enclosure 104, the cathode 106, the insulator 108, the anode 114, the target area 116, the focus area 118, the X-ray window 120, the X-ray beam 122, the electron stream 128, the bearing structure 130, the liquid metal bearing 132, the rotor 134, the stator 136, the shaft 137, and/or the coolant pathways 145 of FIG. 1.

The X-ray assembly 300 may include a cathode focusing structure 320 defining an aperture 322 sized and shaped to encourage the electron stream 324 to travel to the target area 312 of the anode 310. Additionally, the aperture structure 320 may discourage the electron stream 324 from traveling to the housing 302.

In some embodiments, the cathode 306 may have a voltage equal to or less than −225 kV and the anode 310 may have a ground voltage relative to the cathode 306. In some embodiments, the cathode 306 may have a voltage between −225 kV and −300 kV. Alternately, the cathode 306 and the anode 310 may have different voltages such that the voltage difference between the cathode 306 and the anode 310 is greater than 150 kV.

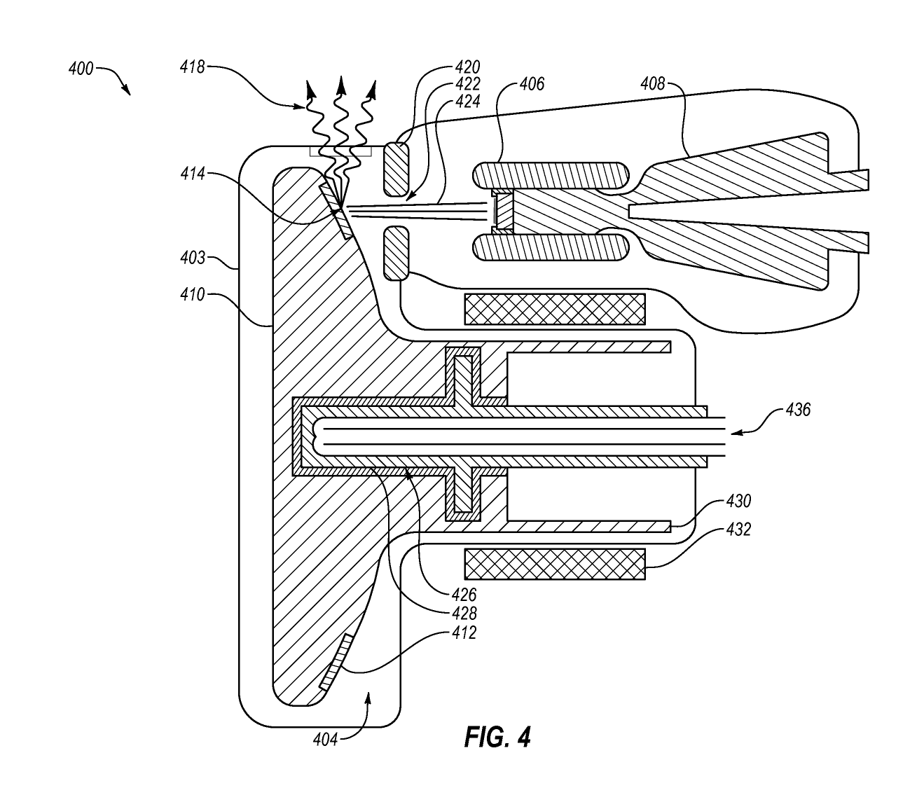

FIG. 4 illustrates a cross-section of an example X-ray assembly 400. The X-ray assembly 400 may include a vacuum wall 402, a vacuum enclosure 404, a cathode 406, an insulator 408, an anode 410, a target area 412, a focus area 414, an X-ray beam 418, an electron stream 424, a bearing structure 426, a liquid metal bearing 428, a rotor 430, a stator 432, and/or coolant pathways 436 generally corresponding, respectively, to the vacuum wall 103, the vacuum enclosure 104, the cathode 106, the insulator 108, the anode 114, the target area 116, the focus area 118, the X-ray window 120, the X-ray beam 122, the electron stream 128, the bearing structure 130, the liquid metal bearing 132, the rotor 134, the stator 136, and/or the coolant pathways 145 of FIG. 1.

The cathode 406 may be located on the same side of the anode 410 as the bearing structure 426. The X-ray assembly 400 may include an aperture structure 420 defining an aperture 422 sized and shaped to encourage the electron stream 424 to travel to the target area 412 of the anode 410. Additionally, the aperture structure 420 may discourage the electron stream 424 from traveling to the vacuum wall 402.

In some embodiments, the cathode 406 may have a voltage equal to or less than −225 kV and the anode 410 may have a ground voltage relative to the cathode 406. Alternately, the cathode 406 and the anode 410 may have different voltages such that the voltage difference between the cathode 406 and the anode 410 is greater than 150 kV.

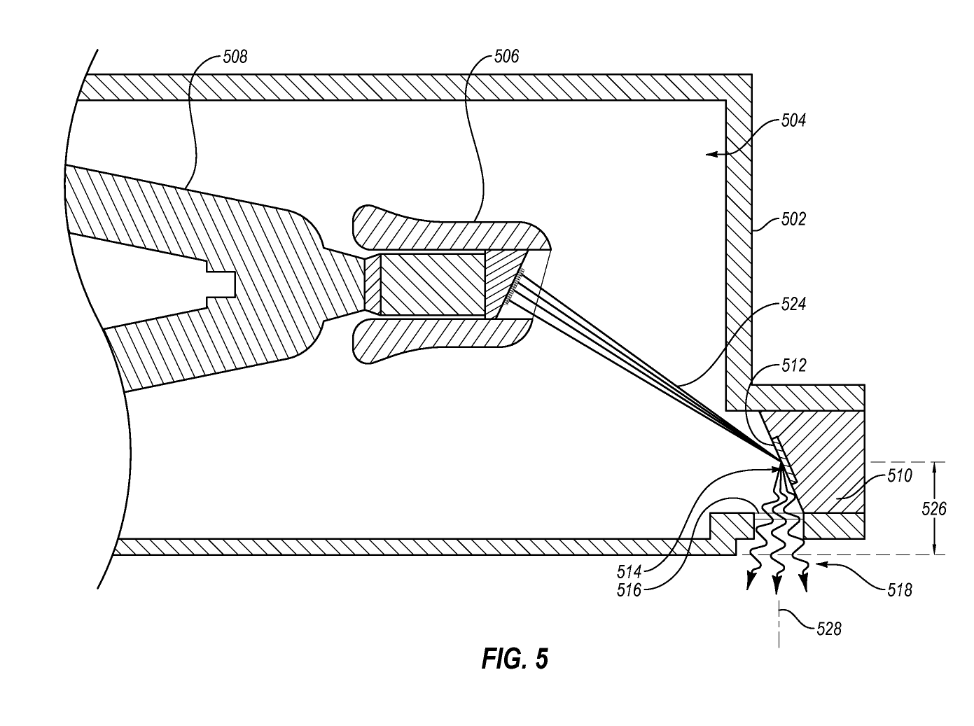

FIG. 5 illustrates a cross-section of an example X-ray assembly 500. In some embodiments, the X-ray assembly 500 may operate at a relatively high voltage, such as a voltage above 150 kilovolts or above 225 kilovolts. The X-ray assembly 500 includes a vacuum wall 502 defining a vacuum enclosure 504.

The X-ray assembly 500 may include a cathode 506, an insulator 508, an X-ray window 516, an X-ray beam 518, an electron stream 524, a virtual line 528, and a distance 526 between the focus area 514 and the vacuum wall 502, generally corresponding, respectively, to the cathode 106, the insulator 108, the X-ray window 120, the X-ray beam 122, the electron stream 128, the virtual line 125, and the distance 131 between the focus area 118 and the housing 102 of FIG. 1. The X-ray assembly 500 may include an anode 510, a target area 512, and a focus area 514. The anode 510 may be a stationary anode, which may remain in place relative to the vacuum wall 502 and the cathode 506 during operation of the X-ray assembly 500. In some embodiments, the vacuum wall 502 may have an approximately cylindrical shape. Optionally, the cathode 506 may be positioned substantially parallel to the axis of the cylindrical shape of the vacuum wall 502.

The cathode 506 of the X-ray assembly may be positioned such that the electron stream 524 travels to the focus area 514 along a path obliquely oriented relative to the virtual line 528 positioned to intersect a center of the focus area 514 and a center of the X-ray window 516. Put another way, the electron stream 518 may travel to the focus area 514 along a path having an oblique orientation relative to a center ray of the X-ray beam 518.

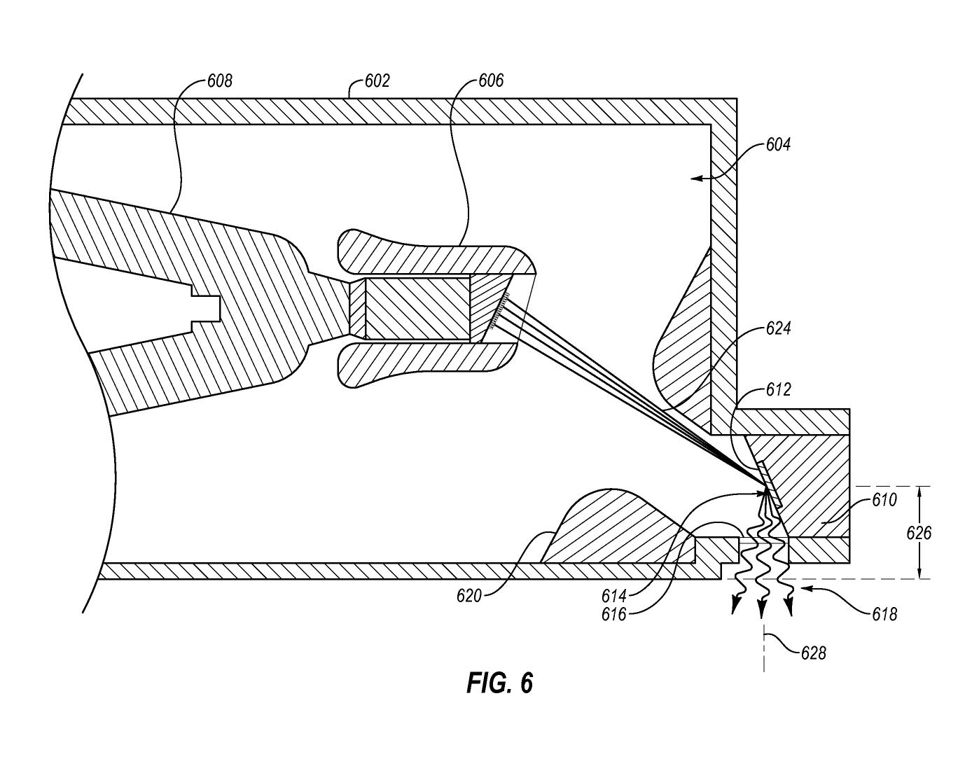

FIG. 6 illustrates a cross-section of an example X-ray assembly 600. In some embodiments, the X-ray assembly 600 may operate at a relatively high voltage, such as a voltage above 150 kilovolts or above 225 kilovolts. The X-ray assembly 600 may include a vacuum wall 602, a vacuum enclosure 604, a cathode 606, an insulator 608, an anode 610, a target area 612, a focus area 614, an X-ray window 616, an X-ray beam 618, an electron stream 624, a virtual line 628, and a distance 626 between the focus area 614 and the vacuum wall 602, generally corresponding, respectively, to the vacuum wall 502, the vacuum enclosure 504, the cathode 506, the insulator 508, the anode 510, the target area 512, the focus area 514, the X-ray window 516, the X-ray beam 518, the electron stream 524, the virtual line 528, and the distance 526 between the focus area 514 and the vacuum wall 502 of FIG. 5. In some embodiments, the vacuum wall 602 may have an approximately cylindrical shape. Optionally, the cathode 606 may be positioned substantially parallel to the axis of the cylindrical shape of the vacuum wall 602.

The X-ray assembly 600 may include an insulator 620. In some embodiments, the insulator 620 may discourage arcing between the cathode and the vacuum wall 602. Alternately or additionally, the insulator 620 may encourage the electron stream 624 to travel to the focus area 616.

The cathode 606 of the X-ray assembly may be positioned such that the electron stream 624 travels to the focus area 614 along a path obliquely oriented relative to the virtual line 628 positioned to intersect a center of the focus area 614 and a center of the X-ray window 616. Put another way, the electron stream 618 may travel to the focus area 614 along a path having an oblique orientation relative to a center ray of the X-ray beam 618.

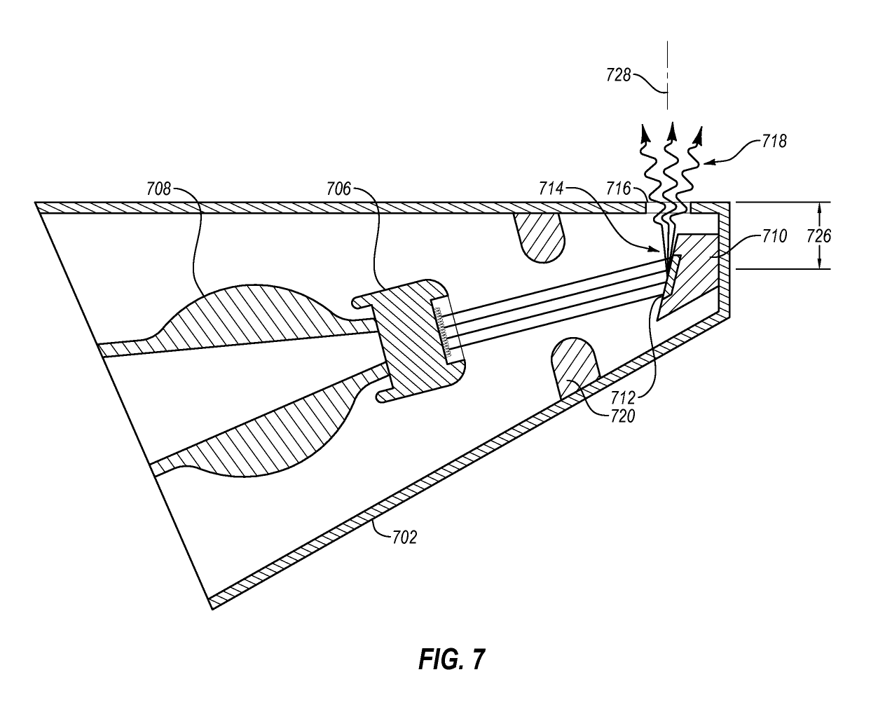

FIG. 7 illustrates a cross-section of an example X-ray assembly 700. In some embodiments, the X-ray assembly 700 may operate at a relatively high voltage, such as a voltage above 150 kilovolts or above 225 kilovolts.

The X-ray assembly 700 may include a vacuum wall 702, a vacuum enclosure 704, a cathode 706, an insulator 708, an X-ray window 716, an X-ray beam 718, an electron stream 724, a virtual line 728, and a distance 726 between the focus area 714 and the vacuum wall 702, generally corresponding, respectively, to the vacuum wall 502, the vacuum enclosure 504, the cathode 506, the insulator 508, the anode 510, the target area 512, the focus area 514, the X-ray window 516, the X-ray beam 518, the electron stream 524, the virtual line 528, and the distance 526 between the focus area 514 and the vacuum wall 502 of FIG. 5. The X-ray assembly 700 may include an insulator 720 generally corresponding to the insulator 620 of FIG. 6.

In some embodiments, the vacuum wall 702 may have an approximately conical or frustoconical shape. Optionally, the cathode 706 and/or the electron stream 724 may be positioned substantially parallel to the axis of the conical or frustoconical shape of the vacuum wall 702.

The cathode 706 of the X-ray assembly may be positioned such that the electron stream 724 travels to the focus area 714 along a path obliquely oriented relative to the virtual line 728 positioned to intersect a center of the focus area 714 and a center of the X-ray window 716. Put another way, the electron stream 718 may travel to the focus area 714 along a path having an oblique orientation relative to a center ray of the X-ray beam 718.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An X-ray assembly comprising:
a vacuum wall including an X-ray window, the vacuum wall defining a vacuum enclosure;
an anode located within the vacuum enclosure, the anode including a target area;
a cathode located within the vacuum enclosure, the cathode configured to produce an electron stream to travel to a focus area located at the target area of the anode, the cathode positioned such that the electron stream travels along an oblique path relative a virtual line positioned so as to intersect a center of the focus area and a center of the X-ray window.

2. The X-ray assembly of claim 1, wherein the anode and cathode are configured to have a difference in voltage above 150 kilovolts.

3. The X-ray assembly of claim 1, wherein the anode and cathode are configured to have a difference in voltage above 225 kilovolts.

4. The X-ray assembly of claim 1, wherein the cathode is obliquely angled relative to the virtual line positioned so as to intersect the center of the focus area and the center of the X-ray window.

5. The X-ray assembly of claim 1, further comprising a bearing structure configured to rotatably position the anode about an axis relative to the vacuum wall.

6. The X-ray assembly of claim 5, wherein the bearing structure includes a liquid metal bearing.

7. The X-ray assembly of claim 1, further comprising an aperture structure defining an aperture located between the cathode and the focus area.

8. The X-ray assembly of claim 7, wherein the aperture structure includes a wall substantially perpendicular to the axis of the anode.

9. An X-ray assembly comprising:
a vacuum wall defining a vacuum enclosure, the vacuum wall including an X-ray window;
an anode located within the vacuum enclosure, the anode including a target area and the anode rotatably positioned about an axis relative to the vacuum wall via a bearing structure including a liquid metal bearing;
a cathode located within the vacuum enclosure, the cathode configured to produce an electron stream to travel to a focus area located at the target area of the anode adjacent the X-ray window of the vacuum wall, the cathode offset from the focus area in a direction parallel to the axis of the anode and in a direction perpendicular to the axis of the anode; and
an aperture structure defining an aperture located between the cathode and the focus area.

10. The X-ray assembly of claim 9, wherein a face of the cathode is angled toward the focus area.

11. The X-ray assembly of claim 9, further comprising an insulator located adjacent to the cathode.

12. The X-ray assembly of claim 9, wherein the anode and cathode are configured to have a difference in voltage above 150 kilovolts.

13. The X-ray assembly of claim 9, wherein the anode has a positive voltage, the cathode has a negative voltage, and the vacuum wall is grounded.

14. The X-ray assembly of claim 9, wherein the anode is grounded.

15. The X-ray assembly of claim 9, wherein the cathode is grounded.

16. The X-ray assembly of claim 9, wherein the aperture structure includes a wall substantially perpendicular to the axis of the anode.

17. The X-ray assembly of claim 9, wherein the aperture structure includes a varying thickness.

18. The X-ray assembly of claim 17, wherein a relatively thicker portion of the structure is located relatively closer to the focus area than a relatively thinner portion of the structure.

19. The X-ray assembly of claim 9, the bearing structure further including cooling passages located in a shaft of the bearing structure.

20. An industrial, sealed X-ray assembly comprising:
a vacuum wall including an X-ray window, the vacuum wall defining a vacuum enclosure;
an anode including a target area;
a bearing structure including a liquid metal bearing, the bearing structure configured to rotatably position the anode relative to the vacuum wall; and
a cathode located within the vacuum enclosure, the cathode configured to produce an electron stream to travel to a focus area located at the target area of the anode adjacent the X-ray window of the vacuum wall,
wherein the cathode and anode are configured to have a voltage difference of greater than 150 kilovolts.
